(19) United States
(12) Patent Application Publication
(10) Pub. No.: US 2020/0349638 A1
(43) Pub. Date: Nov. 5, 2020

(54) STELLAR BANKS EXTERNAL TRANSACTION AGENT FOR INTERNATIONAL REMITTANCE ON STELLAR NETWORK

(71) Applicant: Haim S. Raiz, Cleveland Hts., OH (US)

(72) Inventor: Haim S. Raiz, Cleveland Hts., OH (US)

(21) Appl. No.: 16/536,175

(22) Filed: Aug. 8, 2019

Related U.S. Application Data
(60) Provisional application No. 62/841,071, filed on Apr. 30, 2019.

(51) Int. Cl. G06Q 40/02; H04L 9/06; G06Q 20/10

(52) U.S. Cl. CPC G06Q 40/02; G06Q 20/108; H04L 9/0637

(57) ABSTRACT

Architecture and main solution of a computer software system, which provides banks transaction operations between each other on Stellar blockchain. Bank's blockchain solution allows efficient use of network to provide parallel services of international transactions with real time accepted requirements. Blockchain solution for banks greatly improves global banks connectivity.

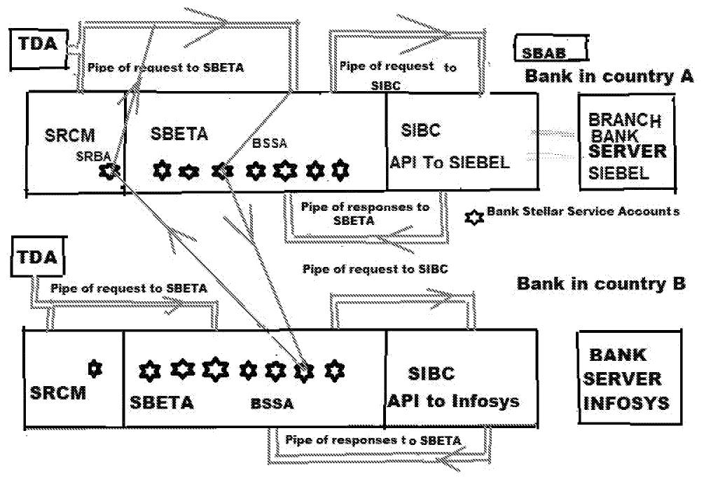

### FIELD

Computer software application for intensive Banks transaction operations on Stellar Blockchain.

### BACKGROUND

Existing systems for bank's remittance do not correspond to contemporary volume, speed, and real time requirements. Existing blockchain-based system Ripple uses two different networks and does not have the option to provide business to business B2B transaction requirements productivity. Efficiency of Ripple could be evaluated just together with SWIFT instant payment, when SWIFT will be serving large number of world banks. For using Ripple solutions banks need to pay for two network.

Invention addresses existing needs and provides solution, which satisfies current requirements and using just one network.

Claimed invention was described in copyright Stellar Bank's External Transaction Agent (SBETA), with registration number of the copyright TXU 2-121-340 and presented on Stellar Building Challenges (SBC) 6 and 7 competitions. Regarding SBC 7 description of invention, it was presented on Jun. 30, 2018 and describes solution providing service for international transactions of Banks on Stellar Network.

### SUMMARY

The invention consists of a structure and organization of computer's software system, which is used to provide intensive banks transaction operations on a digital blockchain network. The main goal of created system solution is to maximize production for bank to bank transactions operations primarily on Stellar blockchain. This system yields a high level of productivity necessary for an intensive mass payment environment or business to business transactions. To reach the required level of productivity, the invention uses a mass service approach together with a simultaneous service of all requests entering the system. For mass service, invention uses network service accounts, which are allocated for each bank and allows the start of service of all inbound and outbound requests immediately and without waiting for completion of other requests. Invention improves bank's international money transfer technology, increases bank funds transfer capacity, provides better reliability, accountability, and reduces cost. Invention allows efficient use of blockchain technology for real time banks transactions. Further advantages and properties of system will become apparent from the detailed description.

### BRIEF DESCRIPTION OF THE DRAWINGS

The drawings contain a schematic view of tasks and interaction between them. The top half portion of drawing presents bank's separate computer system, which interacts with own bank server. The bottom half portion presents other country bank's computer system. Two computers interact with each other using Stellar Network. Task 1 on the view is Stellar Remote Communication Manager (SRCM). Task 2 is SBETA. Task 3 is Stellar Internal Bank Communicator (SIBC). Task Transaction Duty Assignment (TDA) prepares for own bank requests or batch of requests for transactions. Stellar Bank Address Bureau (SBAB) system provides real-time bank's Stellar global key using bank's SWIFT code. SBAB system is not subject of invention.

### DETAILED DESCRIPTION

Invention is based on the idea of creation of a monitor for banks mass service environment that provides parallel interactions between banks with one or multiple banks simultaneously and provides a service of many transaction requests with no or minimum effect of one on another.

One of the requirements is to allow bi-directional dialogs between banks, which makes dialog efficient and complete, but takes more time. To provide a complete dialog and enough productivity for monitor, one must use a mass service approach.

Each bank requires an allocated pool of network accounts for mass service. For each new transaction, the first available account from the pool is used. That way the pool of bank's service accounts provides mass service of inbound or outbound requests without waiting in line for availability of resources.

Structure of monitor “Stellar Banks External Transaction Agent” (SBETA) is built in accordance with mass service solution and bank transaction productivity requirements. SBETA provides multiple services for different steps and different scenarios of all active transactions at the same time. In other words, when each active transaction condition is fulfilled, SBETA executes next step of the scenario. If transaction condition is not fulfilled, SBETA skips the action until the next time cycle. Each time cycle SBETA executes individual steps of scenarios for all active transactions. Basic solution needs to have three tasks, but could be solution with four tasks.

Implementation of basic solution includes three separate interacting tasks, which runs on a Linux-based operating system:

First task consists of monitoring and reading the incoming transaction requests and transferring all data from each request to second task by pipe of requests called “Pipe 1”. Pipe 1 is also used for bank's own transaction requests. All requests are provided with time stamp of entry Pipe1.

Second task SBETA receives a data from input stream of requests from Pipe 1 and interacts with third task by using two pipes. “Pipe 2” keeps requests from SBETA to third task and “Pipe 3” keeps responses from third task to SBETA.

The third task could interact with host bank's core solution by using proper API and web terminal emulation. The third task sends responses with results of host service to SBETA. Responses will get entered in a buffer after state dialog table (STD) with data for that request. Task needs to have an option of providing data for further investigation if compliance requirements are not fulfilled such as a log file with incoming and outgoing funds, accounts numbers, and data of requests.

For certain scenarios, a fourth task could be implemented “Pipe 4” just for requests, which need service similar to the third task, but would run and serve requests requiring additional time for real time compliance checking. Certain real-time money transfers have increased requirements for speed and efficiency of compliance. The possibility of requesting and transferring more information in both directions during the transaction could make real time compliance checking more efficient. Forth task would run with lesser priority than the third task.

Task SBETA provides supervision of processes for execution of all steps for different scenarios (type of bank contracts) until completion of scenario. SBETA checks existence of requests in the “Pipe 1” and reads it, if resources for serving the request are available and idle time does not exceed a certain amount of time. In case of an overloaded system when idle time exceeds some amount, task SBETA would need to discard the request and provide a log file with discarded data. Existence of the discarded requests indicates an overload of the system.

Then task allocates first available service account and writes data of request in the buffer, which keep State Dialog Table (STD) for service account. New request enters in service loop of all requests and will start first step of his scenario.

Events of notifications for change of status of account when data is received or events of response from third task causes transfer to new step of scenario. In case of entrance or existence of requests for transaction, SBETA runs a cycle and checks notifications of events, including events of new requests and new responses. For example, if one of service accounts obtain data and event change of state occurred, then for a normal completion SBETA proceeds in accordance with new step of that scenario. Each independent unfinished transaction remains in memory waits for personal events to continue. Scenarios of sender and scenarios of recipient are different but correspond to each other. Each bank contract should have an identification and have two parts: one for recipient and one for sender. Recipient side gets identification of scenario for what it should to receive.

For sender bank contract SBETA uses network's standard software tools to move funds and messages to recipient site. For the recipient of this scenario (banks contract) SBETA needs read information and places it to appropriate fields of the State Dialog Table (STD).

After receiving transferred funds in bank's service account in any type of currency (stable cryptocurrency such as Tether or another kind), assets could be converted to other kind of stable asset, which eventually will be converted to incoming user account specified currency. Stellar allows to send any kind of assets as credit if bank's service accounts have rights to get it and amount for asset will be less then limit for account. Operation with API for conversion and releasing funds are not subject of invention.

After finishing service of each request, SBETA needs to mark service account as free and clear SDT to make them available for incoming requests. When scenario requires internal host computer service task SBETA transfers request by “Pipe 2” which keeps requests to the host. Third task reads request from “Pipe 2” and emulates web terminal to provide service of request by bank's host computer system.

Currently, there exist a few different bank host computer systems, which provide API as an option of terminal emulation for calling host functions. Task 3 should convert different completion codes of different host computer systems to universal codes for worldwide users, which can be used for interactions of banks with different countries affiliation. For example, code for “account does not exist” should be interpreted properly on both ends when interacting India banks with Infosys and banks with Siebel branch systems.

Responses with completion codes and data from Task 3 transfer to SBETA by “Pipe 3”. To participate in transaction operation on accepted network, all banks should run similar basic services.

Besides for proposed invention, no known system exists that provides international financial transactions with real time clearance and operation on one network, with accepted real time requirements for mass servicing of banks. This invention provides efficient usage of one blockchain network for transferring funds and payment messages between international banks without utilizing global and relatively expensive Society for the Worldwide Interbank Financial Telecommunication (SWIFT) system.

Invention could be used as a tool for providing intense mass servicing of international payments for business to business (B2B). For example, a bank could start transactions of a batch of 12 or more requests to another bank together, and they will be sent and received by both banks at the same time.

SBETA task could provide also an option to start from one bank batch of 12 requests to 12 different banks. That functionality could be important for business to business remote transactions. Number of service accounts for bank could be adjusted if bank experiences delay in service. Any system could be overloaded with requests, when requests arrive in batches similar in size to capacity of bank's service accounts, and banks send batches of requests at the same time. Therefore, it is recommended to send batches for the same bank with number of requests less than full capacity and with time interval between batches a little more than average service time. When incoming transaction requests are evenly distributed in the order they are received, then completion and release from service will also be evenly distributed. In the case of 25 or 30 service accounts or more, expected time of waiting for free service account should be enough for real time intensive service requirements.

One of the novelties is that suggested system uses groups of blockchain individual users accounts, which historically was developed and implemented for individual users, as tools for mass real time servicing of bank's intense international payments and other transactions operations. Network accounts are used for partial steps of bank's dialog to transfer messages and data for all kinds of transactions. Usage of SBETA together with some number of Stellar accounts allocated on network for each bank provides parallel processing of many requests for transactions at the same time and efficiently uses network for bank's operations.

Suggested solution includes a structure and organization for the software of bank's monitor which serves for bank's cross border transaction on Stellar blockchain. Monitor on both sides seamlessly connected to host bank's computer resources to validate and record payment transactions. All different types of transaction between banks presented as Bank's contracts or scenarios. New types of contracts could be programmed and included in service. Bank contract could be accomplished as one step or could be fragmented on few steps. Monitor provide functions of transfer and reception of all running on blockchain bank's transactions. To minimize total service time and rise number of parallel servicing requests for banks, monitor could provide multiple service for steps of different request at each cycle.

Invention efficiently using potential and some aspect of concept Stellar blockchain related to independent network accounts, which could hold different currencies and have developed software tools for secure remote access and for transferring messages, funds and notification of change in status of account. At the same time network did not have special tools to provide required dialog for bank's transactions operations on blockchain, which includes delivery of bank's requests and clearance codes from bank of beneficiary to the bank of sender, checking presence of the funds in bank accounts, seamless recording of transactions for bank, delivery of confirmation numbers, messages about possible errors and parallel service for banks. In invention accepted way of processing Bank's transactions each transaction could be broken on few separate steps, which moving funds and messages between Banks. There is the need to have network, which allow to move more data in one step. That could provide reduction of time for completion of some transaction and reducing of traffic on the network. To secure transferred data Stellar Network provide hash code, which corresponds to transferred data for one step with one direction. In invention hash code created for contents of data of recipient buffer, which could be created as result of few steps of bank interaction. Created hash code delivers to buffer of sender and should be validated by senders by comparison with own hash code. In case if sender could not validate all steps should be repeated. That approach needed to secure bank's financial operations and avoid potential conflicts between banks with different affiliation and could significantly diminish need to resolve conflicts with ledger. Ledger data could have private secrecy for banks and need to have permission access just for bank's records. Encoding and decoding transaction data could be insufficient, because easily accessible experimenting with transaction data could help to find algorithm of encoding.

Accepted solution should satisfy very intense real time payment requirement generated by many banks interacting on network with application like credit or debit card. SBETA particularly should be efficient for remote business to business interaction, because for each new transaction SBETA is allocating from both recipient and sender first available service account and each new transaction typically does not depend of others. Multiple service providing efficient level of productivity and allow to increase volume of transferred information for each transaction to provide confirmation number and clearance keeping total level of bank's transaction productivity high.

The invention claim is:

1. System used together with blockchain could improve money transfer technology by speeding up bank funds transfer capacity, globally increasing volume between bank transactions, providing better reliability and accountability, and making process less expensive.

2. Invention allows efficient use of blockchain technology to improve bank connectivity for real time bank interactions by utilizing simultaneous transactions and inquiries from one bank to many others.

3. System allows operation on just the Stellar Network, which provides the transfer and conversion of funds and messages without usage of SWIFT service on Global Internet, which is the first system that avoids SWIFT service and thereby greatly reduces costs.

4. System organization provides possibility of intensive and abundant cross border payments for credit and debit cards, when there are needs in real time clearance.

5. System provides real-time information about state of transactions on both ends, meaning the sender is informed about recipient error or insufficient funds or vice versa.

6. System provides near real-time clearance via a code that is confirmed by the sender, which includes all elements such as rights checking, existence of required funds, and confirmation by sender's side main data of the request for remittance.

7. System provides simultaneous transactions for each bank with parallel service for different banks or the same bank at the same time.

8. System provides seamless connection to bank's host computers for inquires and recording transactions in real-time on both sides.

9. System provides an option to add different scenarios or banks contracts for payments to various countries with different currencies, taxes, and financial regulations.

10. System provides an option to start and serve batches of requests for transactions from one bank to another bank or from one bank to many banks at the same time, as may be necessary for business to business (B2B) transactions.

11. System provides an option to adjust settlements between banks by using bank contracts, which implement bi-directional dialog and financial regulations.

12. System allows usage of universal completion codes for banks transactions, which simplifies worldwide bank interactions.
